(19) United States
(12) Patent Application Publication
(10) Pub. No.: US 2005/0063298 A1
(43) Pub. Date: Mar. 24, 2005

(54) Synchronization in a broadcast OFDM system using time division multiplexed pilots

(75) Inventors: Fuyun Ling, San Diego, CA (US); Alok Kumar Gupta, Carlsbad, CA (US); Raghuraman Krishnamoorthi, San Diego, CA (US); Ramaswamy Murali, San Diego, CA (US); Rajiv Vijayan, San Diego, CA (US); Bojan Vrcelj, San Diego, CA (US)

Correspondence Address: Qualcomm Incorporated;Patents Department, 5775 Morehouse Drive, San Diego, CA, 92121-1714, US

(73) Assignee: QUALCOMM Incorporated

(21) Appl. No.: 10/931,324

(22) Filed: Aug. 31, 2004

Related U.S. Application Data
(60) Provisional application No. 60/499,951, filed on Sep. 2, 2003.

(51) Int. Cl. H04J 11/00; H04B 3/10; H04J 1/16

(52) U.S. Cl. 370/208; 370/294; 370/491

(57) ABSTRACT

In an OFDM system, a transmitter broadcasts a first TDM pilot on a first set of subbands followed by a second TDM pilot on a second set of subbands in each frame. The subbands in each set are selected from among N total subbands such that (1) an OFDM symbol for the first TDM pilot contains at least S₁ identical pilot-1 sequences of length L₁ and (2) an OFDM symbol for the second TDM pilot contains at least S₂ identical pilot-2 sequences of length L₂, where L₂>L₁, S₁·L₁=N, and S₂·L₂=N. The transmitter may also broadcast an FDM pilot. A receiver processes the first TDM pilot to obtain frame timing (e.g., by performing correlation between different pilot-1 sequences) and further processes the second TDM pilot to obtain symbol timing (e.g., by detecting for the start of a channel impulse response estimate derived from the second TDM pilot).

This application claims the benefit of provisional U.S. Application Ser. No. 60/499,951, entitled “Method for Initial Synchronization in a Multicast Wireless System Using Time-Division Multiplexed Pilot Symbols,” filed Sep. 2, 2003.

### BACKGROUND

I. Field

The present invention relates generally to data communication, and more specifically to synchronization in a wireless broadcast system using orthogonal frequency division multiplexing (OFDM).

II. Background

OFDM is a multi-carrier modulation technique that effectively partitions the overall system bandwidth into multiple (N) orthogonal frequency subbands. These subbands are also referred to as tones, sub-carriers, bins, and frequency channels. With OFDM, each subband is associated with a respective sub-carrier that may be modulated with data.

In an OFDM system, a transmitter processes data to obtain modulation symbols, and further performs OFDM modulation on the modulation symbols to generate OFDM symbols, as described below. The transmitter then conditions and transmits the OFDM symbols via a communication channel. The OFDM system may use a transmission structure whereby data is transmitted in frames, with each frame having a particular time duration. Different types of data (e.g., traffic/packet data, overhead/control data, pilot, and so on) may be sent in different parts of each frame. Pilot generically refers to data and/or transmission that are known a priori by both the transmitter and a receiver.

The receiver typically needs to obtain accurate frame and symbol timing in order to properly recover the data sent by the transmitter. For example, the receiver may need to know the start of each frame in order to properly recover the different types of data sent in the frame. The receiver often does not know the time at which each OFDM symbol is sent by the transmitter nor the propagation delay introduced by the communication channel. The receiver would then need to ascertain the timing of each OFDM symbol received via the communication channel in order to properly perform the complementary OFDM demodulation on the received OFDM symbol.

Synchronization refers to a process performed by the receiver to obtain frame and symbol timing. The receiver may also perform other tasks, such as frequency error estimation, as part of synchronization. The transmitter typically expends system resources to support synchronization, and the receiver also consumes resources to perform synchronization. Since synchronization is overhead needed for data transmission, it is desirable to minimize the amount of resources used by both the transmitter and receiver for synchronization.

There is therefore a need in the art for techniques to efficiently achieve synchronization in a broadcast OFDM system.

### SUMMARY

Techniques for achieving synchronization using time division multiplexed (TDM) pilots in an OFDM system are described herein. In each frame (e.g., at the start of the frame), a transmitter broadcasts or transmits a first TDM pilot on a first set of subbands followed by a second TDM pilot on a second set of subbands. The first set contains L₁ subbands and the second set contains L₂ subbands, where L₁ and L₂ are each a fraction of the N total subbands, and L₂>L₁. The subbands in each set may be uniformly distributed across the N total subbands such that (1) the L₁ subbands in the first set are equally spaced apart by S₁=N/L₁ subbands and (2) the L₂ subbands in the second set are equally spaced apart by S₂=N/L₂ subbands. This pilot structure results in (1) an OFDM symbol for the first TDM pilot containing at least S₁ identical “pilot-1” sequences, with each pilot-1 sequence containing L₁ time-domain samples, and (2) an OFDM symbol for the second TDM pilot containing at least S₂ identical “pilot-2” sequences, with each pilot-2 sequence containing L₂ time-domain samples. The transmitter may also transmit a frequency division multiplexed (FDM) pilot along with data in the remaining part of each frame. This pilot structure with the two TDM pilots is well suited for a broadcast system but may also be used for non-broadcast systems.

A receiver can perform synchronization based on the first and second TDM pilots. The receiver can process the first TDM pilot to obtain frame timing and frequency error estimate. The receiver may compute a detection metric based on a delayed correlation between different pilot-1 sequences for the first TDM pilot, compare the detection metric against a threshold, and declare detection of the first TDM pilot (and thus a frame) based on the comparison result. The receiver can also obtain an estimate of the frequency error in the received OFDM symbol based on the pilot-1 sequences. The receiver can process the second TDM pilot to obtain symbol timing and a channel estimate. The receiver may derive a channel impulse response estimate based on a received OFDM symbol for the second TDM pilot, detect the start of the channel impulse response estimate (e.g., based on the energy of the channel taps for the channel impulse response), and derive the symbol timing based on the detected start of the channel impulse response estimate. The receiver may also derive a channel frequency response estimate for the N total subbands based on the channel impulse response estimate. The receiver may use the first and second TDM pilots for initial synchronization and may use the FDM pilot for frequency and time tracking and for more accurate channel estimation.

Various aspects and embodiments of the invention are described in further detail below.

### BRIEF DESCRIPTION OF THE DRAWINGS

The features and nature of the present invention will become more apparent from the detailed description set forth below when taken in conjunction with the drawings in which like reference characters identify correspondingly throughout and wherein:

FIG. 1 shows a base station and a wireless device in an OFDM system;

FIG. 2 shows a super-frame structure for the OFDM system;

FIGS. 3A and 3B show frequency-domain representations of TDM pilots 1 and 2, respectively;

FIG. 4 shows a transmit (TX) data and pilot processor;

FIG. 5 shows an OFDM modulator;

FIGS. 6A and 6B show time-domain representations of TDM pilots 1 and 2;

FIG. 7 shows a synchronization and channel estimation unit;

FIG. 8 shows a frame detector;

FIG. 9 shows a symbol timing detector;

FIGS. 10A through 10C show processing for a pilot-2 OFDM symbol; and

FIG. 11 shows a pilot transmission scheme with TDM and FDM pilots.

### DETAILED DESCRIPTION

The word “exemplary” is used herein to mean “serving as an example, instance, or illustration.” Any embodiment or design described herein as “exemplary” is not necessarily to be construed as preferred or advantageous over other embodiments or designs.

The synchronization techniques described herein may be used for various multi-carrier systems and for the downlink as well as the uplink. The downlink (or forward link) refers to the communication link from the base stations to the wireless devices, and the uplink (or reverse link) refers to the communication link from the wireless devices to the base stations. For clarity, these techniques are described below for the downlink in an OFDM system.

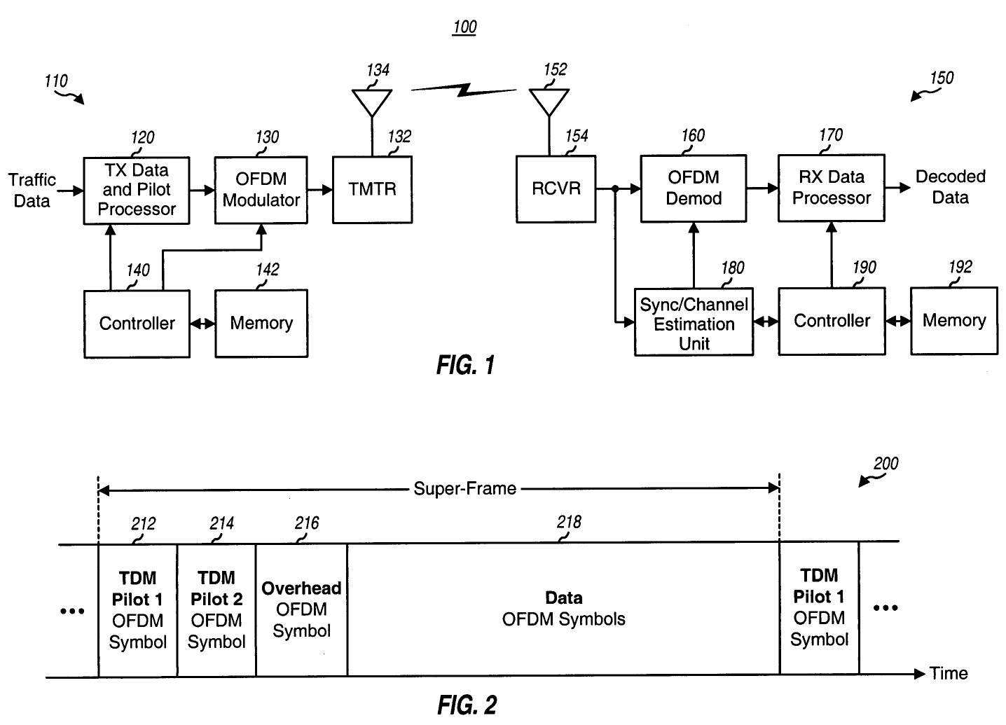

FIG. 1 shows a block diagram of a base station 110 and a wireless device 150 in an OFDM system 100. Base station 110 is generally a fixed station and may also be referred to as a base transceiver system (BTS), an access point, or some other terminology. Wireless device 150 may be fixed or mobile and may also be referred to as a user terminal, a mobile station, or some other terminology. Wireless device 150 may also be a portable unit such as a cellular phone, a handheld device, a wireless module, a personal digital assistant (PDA), and so on.

At base station 110, a TX data and pilot processor 120 receives different types of data (e.g., traffic/packet data and overhead/control data) and processes (e.g., encodes, interleaves, and symbol maps) the received data to generate data symbols. As used herein, a “data symbol” is a modulation symbol for data, a “pilot symbol” is a modulation symbol for pilot, and a modulation symbol is a complex value for a point in a signal constellation for a modulation scheme (e.g., M-PSK, M-QAM, and so on). Processor 120 also processes pilot data to generate pilot symbols and provides the data and pilot symbols to an OFDM modulator 130.

OFDM modulator 130 multiplexes the data and pilot symbols onto the proper subbands and symbol periods and further performs OFDM modulation on the multiplexed symbols to generate OFDM symbols, as described below. A transmitter unit (TMTR) 132 converts the OFDM symbols into one or more analog signals and further conditions (e.g., amplifies, filters, and frequency upconverts) the analog signal(s) to generate a modulated signal. Base station 110 then transmits the modulated signal from an antenna 134 to wireless devices in the system.

At wireless device 150, the transmitted signal from base station 110 is received by an antenna 152 and provided to a receiver unit (RCVR) 154. Receiver unit 154 conditions (e.g., filters, amplifies, and frequency downconverts) the received signal and digitizes the conditioned signal to obtain a stream of input samples. An OFDM demodulator 160 performs OFDM demodulation on the input samples to obtain received data and pilot symbols. OFDM demodulator 160 also performs detection (e.g., matched filtering) on the received data symbols with a channel estimate (e.g., a frequency response estimate) to obtain detected data symbols, which are estimates of the data symbols sent by base station 110. OFDM demodulator 160 provides the detected data symbols to a receive (RX) data processor 170.

A synchronization/channel estimation unit 180 receives the input samples from receiver unit 154 and performs synchronization to determine frame and symbol timing, as described below. Unit 180 also derives the channel estimate using received pilot symbols from OFDM demodulator 160. Unit 180 provides the symbol timing and channel estimate to OFDM demodulator 160 and may provide the frame timing to RX data processor 170 and/or a controller 190. OFDM demodulator 160 uses the symbol timing to perform OFDM demodulation and uses the channel estimate to perform detection on the received data symbols.

RX data processor 170 processes (e.g., symbol demaps, deinterleaves, and decodes) the detected data symbols from OFDM demodulator 160 and provides decoded data. RX data processor 170 and/or controller 190 may use the frame timing to recover different types of data sent by base station 110. In general, the processing by OFDM demodulator 160 and RX data processor 170 is complementary to the processing by OFDM modulator 130 and TX data and pilot processor 120, respectively, at base station 110.

Controllers 140 and 190 direct operation at base station 110 and wireless device 150, respectively. Memory units 142 and 192 provide storage for program codes and data used by controllers 140 and 190, respectively.

Base station 110 may send a point-to-point transmission to a single wireless device, a multi-cast transmission to a group of wireless devices, a broadcast transmission to all wireless devices under its coverage area, or any combination thereof. For example, base station 110 may broadcast pilot and overhead/control data to all wireless devices under its coverage area. Base station 110 may further transmit user-specific data to specific wireless devices, multi-cast data to a group of wireless devices, and/or broadcast data to all wireless devices.

FIG. 2 shows a super-frame structure 200 that may be used for OFDM system 100. Data and pilot may be transmitted in super-frames, with each super-frame having a predetermined time duration. A super-frame may also be referred to as a frame, a time slot, or some other terminology. For the embodiment shown in FIG. 2, each super-frame includes a field 212 for a first TDM pilot (or “TDM pilot 1”), a field 214 for a second TDM pilot (or “TDM pilot 2”), a field 216 for overhead/control data, and a field 218 for traffic/packet data.

The four fields 212 through 218 are time division multiplexed in each super-frame such that only one field is transmitted at any given moment. The four fields are also arranged in the order shown in FIG. 2 to facilitate synchronization and data recovery. Pilot OFDM symbols in fields 212 and 214, which are transmitted first in each super-frame, may be used for detection of overhead OFDM symbols in field 216, which is transmitted next in the super-frame. Overhead information obtained from field 216 may then be used for recovery of traffic/packet data sent in field 218, which is transmitted last in the super-frame.

In an embodiment, field 212 carries one OFDM symbol for TDM pilot 1, and field 214 also carries one OFDM symbol for TDM pilot 2. In general, each field may be of any duration, and the fields may be arranged in any order. TDM pilots 1 and 2 are broadcast periodically in each frame to facilitate synchronization by the wireless devices. Overhead field 216 and/or data field 218 may also contain pilot symbols that are frequency division multiplexed with data symbols, as described below.

The OFDM system has an overall system bandwidth of BW MHz, which is partitioned into N orthogonal subbands using OFDM. The spacing between adjacent subbands is BW/N MHz. Of the N total subbands, M subbands may be used for pilot and data transmission, where M<N, and the remaining N−M subbands may be unused and serve as guard subbands. In an embodiment, the OFDM system uses an OFDM structure with N=4096 total subbands, M=4000 usable subbands, and N−M=96 guard subbands. In general, any OFDM structure with any number of total, usable, and guard subbands may be used for the OFDM system.

TDM pilots 1 and 2 may be designed to facilitate synchronization by the wireless devices in the system. A wireless device may use TDM pilot 1 to detect the start of each frame, obtain a coarse estimate of symbol timing, and estimate frequency error. The wireless device may use TDM pilot 2 to obtain more accurate symbol timing.

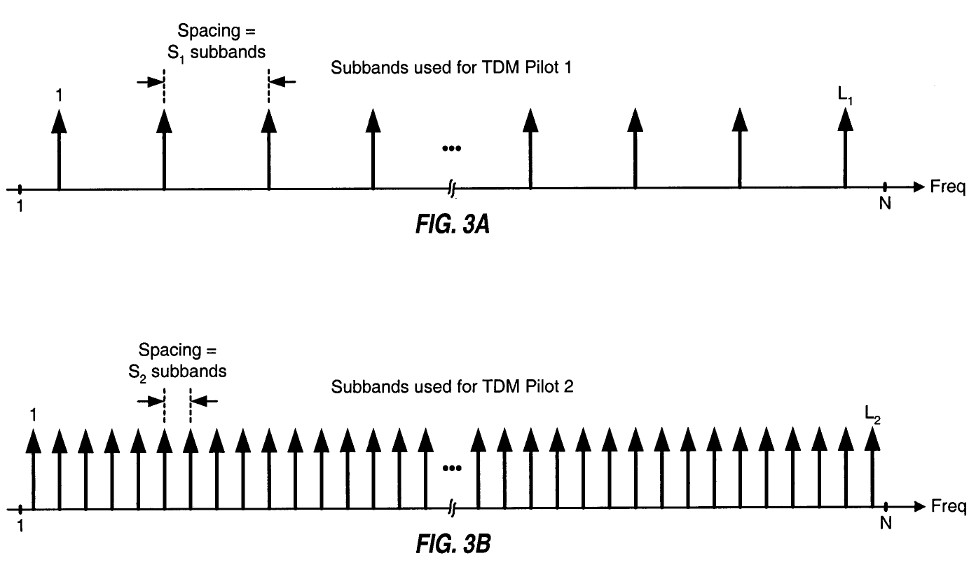

FIG. 3A shows an embodiment of TDM pilot 1 in the frequency domain. For this embodiment, TDM pilot 1 comprises L₁ pilot symbols that are transmitted on L₁ subbands, one pilot symbol per subband used for TDM pilot 1. The L₁ subbands are uniformly distributed across the N total subbands and are equally spaced apart by S₁ subbands, where S₁=N/L₁. For example, N=4096, L₁=128, and S₁=32. However, other values may also be used for N, L₁, and S₁. This structure for TDM pilot 1 can (1) provide good performance for frame detection in various types of channel including a severe multi-path channel, (2) provide a sufficiently accurate frequency error estimate and coarse symbol timing in a severe multi-path channel, and (3) simplify the processing at the wireless devices, as described below.

FIG. 3B shows an embodiment of TDM pilot 2 in the frequency domain. For this embodiment, TDM pilot 2 comprises L₂ pilot symbols that are transmitted on L₂ subbands, where L₂>L₁. The L₂ subbands are uniformly distributed across the N total subbands and are equally spaced apart by S₂ subbands, where S₂=N/L₂. For example, N=4096, L₂=2048, and S₂=2. Again, other values may also be used for N, L₂, and S₂. This structure for TDM pilot 2 can provide accurate symbol timing in various types of channel including a severe multi-path channel. The wireless devices may also be able to (1) process TDM pilot 2 in an efficient manner to obtain symbol timing prior to the arrival of the next OFDM symbol, which is right after TDM pilot 2, and (2) apply the symbol timing to this next OFDM symbol, as described below.

A smaller value is used for L₁ so that a larger frequency error can be corrected with TDM pilot 1. A larger value is used for L₂ so that the pilot-2 sequence is longer, which allows a wireless device to obtain a longer channel impulse response estimate from the pilot-2 sequence. The L₁ subbands for TDM pilot 1 are selected such S₁ identical pilot-1 sequences are generated for TDM pilot 1. Similarly, the L₂ subbands for TDM pilot 2 are selected such S₂ identical pilot-2 sequences are generated for TDM pilot 2.

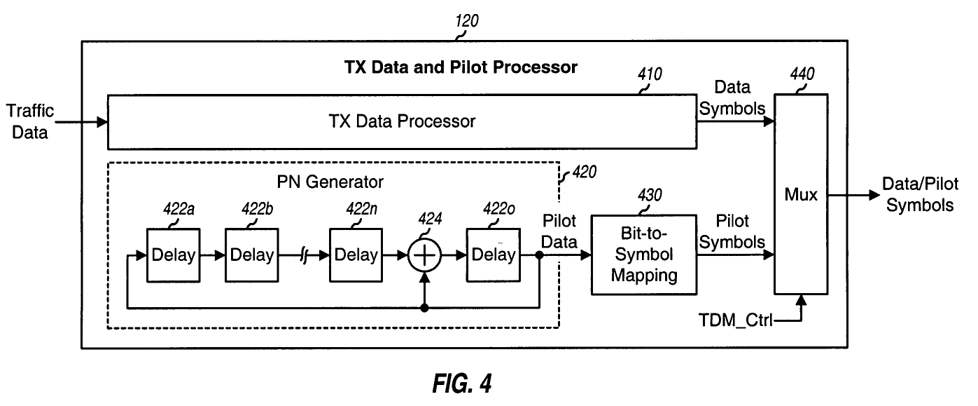

FIG. 4 shows a block diagram of an embodiment of TX data and pilot processor 120 at base station 110. Within processor 120, a TX data processor 410 receives, encodes, interleaves, and symbol maps traffic/packet data to generate data symbols.

In an embodiment, a pseudo-random number (PN) generator 420 is used to generate data for both TDM pilots 1 and 2. PN generator 420 may be implemented, for example, with a 15-tap linear feedback shift register (LFSR) that implements a generator polynomial g(x)=x¹⁵+x¹⁴+1. In this case, PN generator 420 includes (1) 15 delay elements 422a through 422o coupled in series and (2) a summer 424 coupled between delay elements 422n and 422o. Delay element 422o provides pilot data, which is also fed back to the input of delay element 422a and to one input of summer 424. PN generator 420 may be initialized with different initial states for TDM pilots 1 and 2, e.g., to ‘011010101001110’ for TDM pilot 1 and to ‘010110100011100’ for TDM pilot 2. In general, any data may be used for TDM pilots 1 and 2. The pilot data may be selected to reduce the difference between the peak amplitude and the average amplitude of a pilot OFDM symbol (i.e., to minimize the peak-to-average variation in the time-domain waveform for the TDM pilot). The pilot data for TDM pilot 2 may also be generated with the same PN generator used for scrambling data. The wireless devices have knowledge of the data used for TDM pilot 2 but do not need to know the data used for TDM pilot 1.

A bit-to-symbol mapping unit 430 receives the pilot data from PN generator 420 and maps the bits of the pilot data to pilot symbols based on a modulation scheme. The same or different modulation schemes may be used for TDM pilots 1 and 2. In an embodiment, QPSK is used for both TDM pilots 1 and 2. In this case, mapping unit 430 groups the pilot data into 2-bit binary values and further maps each 2-bit value to a specific pilot modulation symbol. Each pilot symbol is a complex value in a signal constellation for QPSK. If QPSK is used for the TDM pilots, then mapping unit 430 maps 2L, pilot data bits for TDM pilot 1 to L₁ pilot symbols and further maps 2L₂ pilot data bits for TDM pilot 2 to L₂ pilot symbols. A multiplexer (Mux) 440 receives the data symbols from TX data processor 410, the pilot symbols from mapping unit 430, and a TDM_Ctrl signal from controller 140. Multiplexer 440 provides to OFDM modulator 130 the pilot symbols for the TDM pilot 1 and 2 fields and the data symbols for the overhead and data fields of each frame, as shown in FIG. 2.

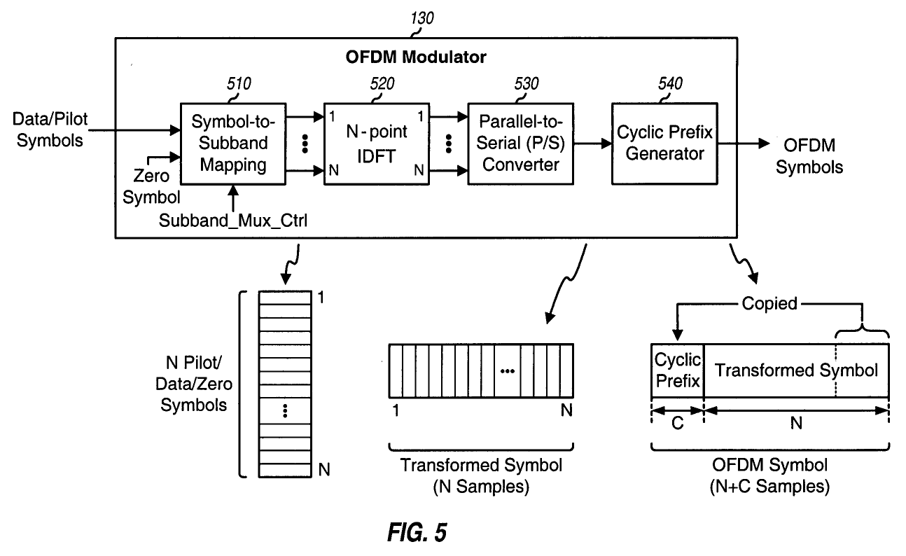

FIG. 5 shows a block diagram of an embodiment of OFDM modulator 130 at base station 110. A symbol-to-subband mapping unit 510 receives the data and pilot symbols from TX data and pilot processor 120 and maps these symbols onto the proper subbands based on a Subband_Mux_Ctrl signal from controller 140. In each OFDM symbol period, mapping unit 510 provides one data or pilot symbol on each subband used for data or pilot transmission and a “zero symbol” (which is a signal value of zero) for each unused subband. The pilot symbols designated for subbands that are not used are replaced with zero symbols. For each OFDM symbol period, mapping unit 510 provides N “transmit symbols” for the N total subbands, where each transmit symbol may be a data symbol, a pilot symbol, or a zero symbol. An inverse discrete Fourier transform (IDFT) unit 520 receives the N transmit symbols for each OFDM symbol period, transforms the N transmit symbols to the time domain with an N-point IDFT, and provides a “transformed” symbol that contains N time-domain samples. Each sample is a complex value to be sent in one sample period. An N-point inverse fast Fourier transform (IFFT) may also be performed in place of an N-point IDFT if N is a power of two, which is typically the case. A parallel-to-serial (P/S) converter 530 serializes the N samples for each transformed symbol. A cyclic prefix generator 540 then repeats a portion (or C samples) of each transformed symbol to form an OFDM symbol that contains N+C samples. The cyclic prefix is used to combat inter-symbol interference (ISI) and intercarrier interference (ICI) caused by a long delay spread in the communication channel. Delay spread is the time difference between the earliest arriving signal instance and the latest arriving signal instance at a receiver. An OFDM symbol period (or simply, a “symbol period”) is the duration of one OFDM symbol and is equal to N+C sample periods.

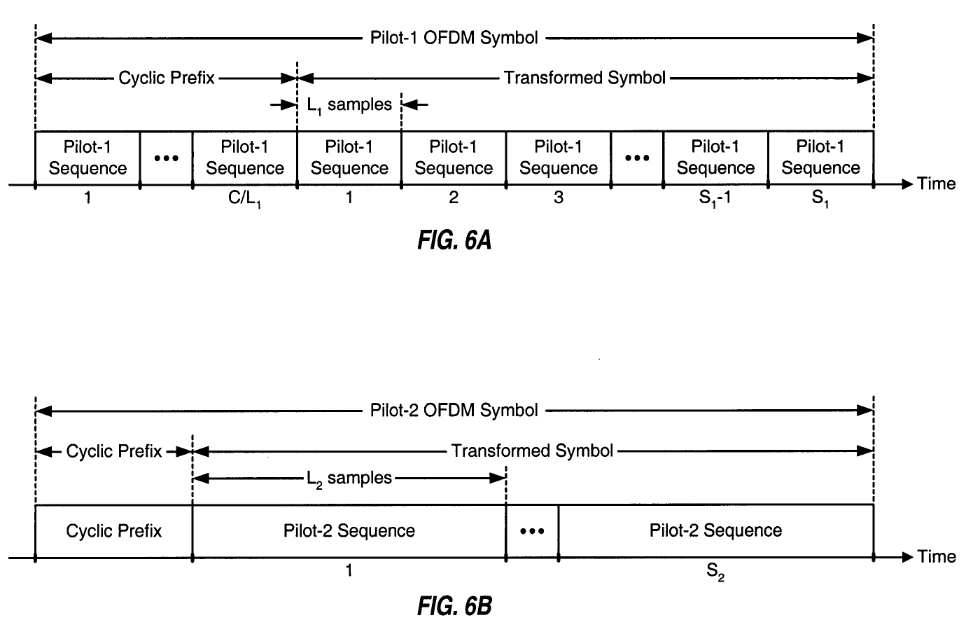

FIG. 6A shows a time-domain representation of TDM pilot 1. An OFDM symbol for TDM pilot 1 (or “pilot-1 OFDM symbol”) is composed of a transformed symbol of length N and a cyclic prefix of length C. Because the L₁ pilot symbols for TDM pilot 1 are sent on L₁ subbands that are evenly spaced apart by S₁ subbands, and because zero symbols are sent on the remaining subbands, the transformed symbol for TDM pilot 1 contains S1 identical pilot-1 sequences, with each pilot-1 sequence containing L₁ time-domain samples. Each pilot-1 sequence may also be generated by performing an L₁-point IDFT on the L₁ pilot symbols for TDM pilot 1. The cyclic prefix for TDM pilot 1 is composed of the C rightmost samples of the transformed symbol and is inserted in front of the transformed symbol. The pilot-1 OFDM symbol thus contains a total of S₁+C/L₁ pilot-1 sequences. For example, if N=4096, L₁=128, S₁=32, and C=512, then the pilot-1 OFDM symbol would contain 36 pilot-1 sequences, with each pilot-1 sequence containing 128 time-domain samples.

FIG. 6B shows a time-domain representation of TDM pilot 2. An OFDM symbol for TDM pilot 2 (or “pilot-2 OFDM symbol”) is also composed of a transformed symbol of length N and a cyclic prefix of length C. The transformed symbol for TDM pilot 2 contains S₂ identical pilot-2 sequences, with each pilot-2 sequence containing L₂ time-domain samples. The cyclic prefix for TDM pilot 2 is composed of the C rightmost samples of the transformed symbol and is inserted in front of the transformed symbol. For example, if N=4096, L₂=2048, S₂=2, and C=512, then the pilot-2 OFDM symbol would contain two complete pilot-2 sequences, with each pilot-2 sequence containing 2048 time-domain samples. The cyclic prefix for TDM pilot 2 would contain only a portion of the pilot-2 sequence.

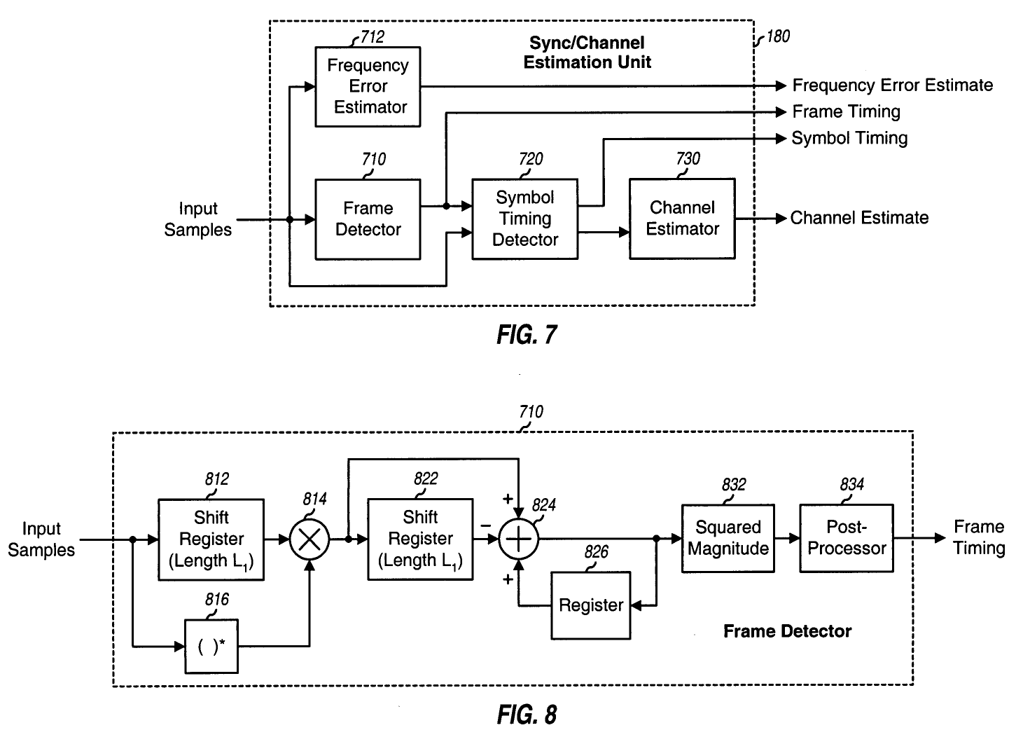

FIG. 7 shows a block diagram of an embodiment of synchronization and channel estimation unit 180 at wireless device 150. Within unit 180, a frame detector 710 receives the input samples from receiver unit 154, processes the input samples to detect for the start of each frame, and provides the frame timing. A symbol timing detector 720 receives the input samples and the frame timing, processes the input samples to detect for the start of the received OFDM symbols, and provides the symbol timing. A frequency error estimator 712 estimates the frequency error in the received OFDM symbols. A channel estimator 730 receives an output from symbol timing detector 720 and derives the channel estimate. The detectors and estimators in unit 180 are described below.

FIG. 8 shows a block diagram of an embodiment of frame detector 710, which performs frame synchronization by detecting for TDM pilot 1 in the input samples from receiver unit 154. For simplicity, the following description assumes that the communication channel is an additive white Gaussian noise (AWGN) channel. The input sample for each sample period may be expressed as:
rₙ=xₙ+wₙ Eq (1)
where
n is an index for sample period;
xₙ is a time-domain sample sent by the base station in sample period n;
rₙ is an input sample obtained by the wireless device in sample period n; and
wₙ is the noise for sample period n.

For the embodiment shown in FIG. 8, frame detector 710 is implemented with a delayed correlator that exploits the periodic nature of the pilot-1 OFDM symbol for frame detection. In an embodiment, frame detector 710 uses the following detection metric for frame detection:

$${S}_{n} = \vert {\sum }_{i = n - {L}_{1} + 1}^{n} {r}_{i - {L}_{1}} \cdot {r}_{i}^{*} {\vert}^{2} , \qquad Eq ( 2 )$$

where
Sₙ is the detection metric for sample period n;
“*” denotes a complex conjugate; and
   |x|² denotes the squared magnitude of x.
   Equation (2) computes a delayed correlation between two input samples rᵢ and r_{i-L}_{₁} in two consecutive pilot-1 sequences, or cᵢ=r_{i-L}_{ᵢ}·rᵢ*. This delayed correlation removes the effect of the communication channel without requiring a channel gain estimate and further coherently combines the energy received via the communication channel. Equation (2) then accumulates the correlation results for all L₁ samples of a pilot-1 sequence to obtain an accumulated correlation result Cₙ, which is a complex value. Equation (2) then derives the decision metric Sₙ for sample period n as the squared magnitude of Cₙ. The decision metric Sₙ is indicative of the energy of one received pilot-1 sequence of length L₁, if there is a match between the two sequences used for the delayed correlation.

Within frame detector 710, a shift register 812 (of length L₁) receives, stores, and shifts the input samples {rₙ} and provides input samples {r_{n-L}_{₁}} that have been delayed by L₁ sample periods. A sample buffer may also be used in place of shift register 812. A unit 816 also receives the input samples and provides the complex-conjugated input samples {rₙ*} For each sample period n, a multiplier 814 multiplies the delayed input sample r_{n-L}_{₁} from shift register 812 with the complex-conjugated input sample rₙ* from unit 816 and provides a correlation result cₙ to a shift register 822 (of length L₁) and a summer 824. Lower-case cₙ denotes the correlation result for one input sample, and upper-case Cₙ denotes the accumulated correlation result for L₁ input samples. Shift register 822 receives, stores, and delays the correlation results {cₙ} from multiplier 814 and provides correlation results {c_{n-L}_{₁}} that have been delayed by L₁ sample periods. For each sample period n, summer 824 receives and sums the output Cₙ₋₁ of a register 826 with the result cₙ from multiplier 814, further subtracts the delayed result c_{n-L}_{₁} from shift register 822, and provides its output Cₙ to register 826. Summer 824 and register 826 form an accumulator that performs the summation operation in equation (2). Shift register 822 and summer 824 are also configured to perform a running or sliding summation of the L₁ most recent correlation results cₙ through c_{n-L}_{₁}₊₁. This is achieved by summing the most recent correlation result cₙ from multiplier 814 and subtracting out the correlation result c_{n-L}_{₁} from L₁ sample periods earlier, which is provided by shift register 822. A unit 832 computes the squared magnitude of the accumulated output Cₙ from summer 824 and provides the detection metric Sₙ.

A post-processor 834 detects for the presence of the pilot-1 OFDM symbol, and hence the start of the super-frame, based on the detection metric Sₙ and a threshold Sₜₕ, which may be a fixed or programmable value. The frame detection may be based on various criteria. For example, post-processor 834 may declare the presence of a pilot-1 OFDM symbol if the detection metric Sₙ (1) exceeds the threshold Sₜₕ, (2) remains above the threshold Sₜₕ for at least a predetermined percentage of the pilot-1 OFDM symbol duration, and (3) falls below the threshold Sₜₕ for a predetermined time period (one pilot-1 sequence) thereafter. Post-processor 834 may indicate the end of the pilot-1 OFDM symbol (denoted as T_{C}) as a predetermined number of sample periods prior to the trailing edge of the waveform for the detection metric Sₙ. Post-processor 834 may also set a Frame Timing signal (e.g., to logic high) at the end of the pilot-1 OFDM symbol. The time T_{C} may be used as a coarse symbol timing for the processing of the pilot-2 OFDM symbol.

Frequency error estimator 712 estimates the frequency error in the received pilot-1 OFDM symbol. This frequency error may be due to various sources such as, for example, a difference in the frequencies of the oscillators at the base station and wireless device, Doppler shift, and so on. Frequency error estimator 712 may generate a frequency error estimate for each pilot-1 sequence (except for the last pilot-1 sequence), as follows:

$$Δ {f}_{l} = \frac{1}{{G}_{D}} Arg [ {\sum }_{i = 1}^{{L}_{1}} {r}_{l , i} \cdot {r}_{l , i + {L}_{1}}^{*} ] , \qquad Eq ( 3 )$$

where
r_{l,i} is the i-th input sample for the l-th pilot-1 sequence;
Arg (x) is the arc-tangent of the ratio of the imaginary component of x over the real component of x, or Arg (x)=arctan [Im(x)/Re(x)];
G_{D} is a detector gain, which is

$${G}_{D} = \frac{2 π \cdot L}{{f}_{samp}} ;$$
and
Δfₗ is the frequency error estimate for the l-th pilot-1 sequence.
The range of detectable frequency errors may be given as:

$$2 π \cdot {L}_{1} \cdot \frac{\vert Δ {f}_{l} \vert}{{f}_{samp}} < π / 2 , or \vert Δ {f}_{l} \vert < \frac{{f}_{samp}}{4 \cdot {L}_{1}} , \qquad Eq ( 4 )$$

where fₛₐₘₚ is the input sample rate. Equation (4) indicates that the range of detected frequency errors is dependent on, and inversely related to, the length of the pilot-1 sequence. Frequency error estimator 712 may also be implemented within post-processor 834 since the accumulated correlation results are also available from summer 824.

The frequency error estimates may be used in various manners. For example, the frequency error estimate for each pilot-1 sequence may be used to update a frequency tracking loop that attempts to correct for any detected frequency error at the wireless device. The frequency tracking loop may be a phase-locked loop (PLL) that can adjust the frequency of a carrier signal used for frequency downconversion at the wireless device. The frequency error estimates may also be averaged to obtain a single frequency error estimate Δf for the pilot-1 OFDM symbol. This Δf may then be used for frequency error correction either prior to or after the N-point DFT within OFDM demodulator 160. For post-DFT frequency error correction, which may be used to correct a frequency offset Δf that is an integer multiple of the subband spacing, the received symbols from the N-point DFT may be translated by Δf subbands, and a frequency-corrected symbol \tilde{R}ₖ for each applicable subband k may be obtained as \tilde{R}ₖ=\tilde{R}_{k+Δf}. For pre-DFT frequency error correction, the input samples may be phase rotated by the frequency error estimate Δf, and the N-point DFT may then be performed on the phase-rotated samples.

Frame detection and frequency error estimation may also be performed in other manners based on the pilot-1 OFDM symbol, and this is within the scope of the invention. For example, frame detection may be achieved by performing a direct correlation between the input samples for pilot-1 OFDM symbol with the actual pilot-1 sequence generated at the base station. The direct correlation provides a high correlation result for each strong signal instance (or multipath). Since more than one multipath or peak may be obtained for a given base station, a wireless device would perform post-processing on the detected peaks to obtain timing information. Frame detection may also be achieved with a combination of delayed correlation and direct correlation.

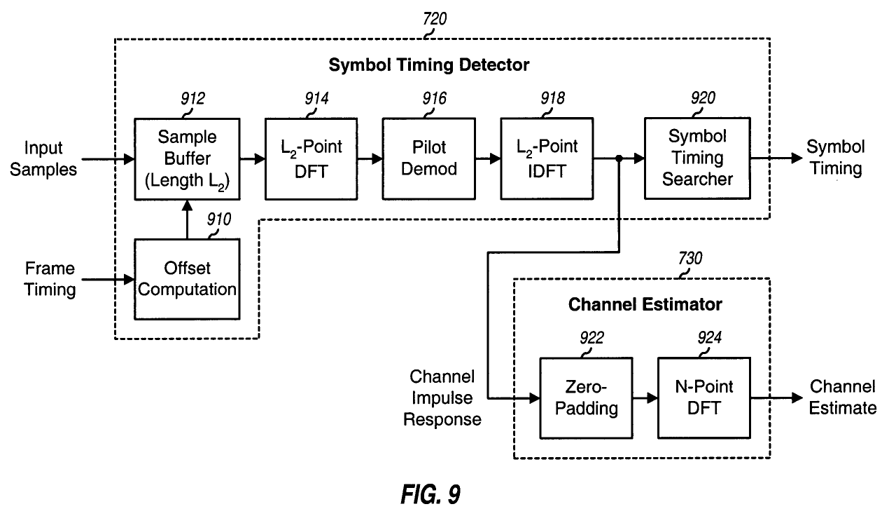

FIG. 9 shows a block diagram of an embodiment of symbol timing detector 720, which performs timing synchronization based on the pilot-2 OFDM symbol. Within symbol timing detector 720, a sample buffer 912 receives the input samples from receiver unit 154 and stores a “sample” window of L₂ input samples for the pilot-2 OFDM symbol. The start of the sample window is determined by a unit 910 based on the frame timing from frame detector 710.

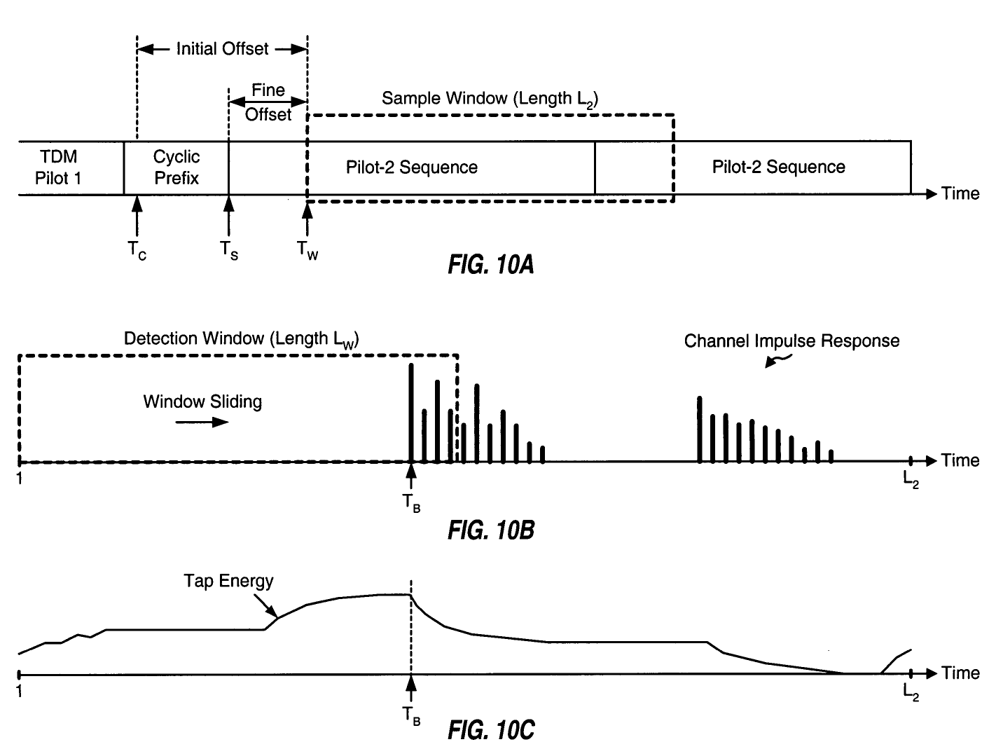

FIG. 10A shows a timing diagram of the processing for the pilot-2 OFDM symbol. Frame detector 710 provides the coarse symbol timing (denoted as T_{C}) based on the pilot-1 OFDM symbol. The pilot-2 OFDM symbol contains S₂ identical pilot-2 sequences of length L₂ (e.g., two pilot-2 sequences of length 2048 if N=4096 and L₂=2048). A window of L₂ input samples is collected by sample buffer 912 for the pilot-2 OFDM symbol starting at sample period T_{W}. The start of the sample window is delayed by an initial offset OSᵢₙᵢₜ from the coarse symbol timing, or T_{W}=T_{C}+OSᵢₙᵢₜ. The initial offset does not need to be accurate and is selected to ensure that one complete pilot-2 sequence is collected in sample buffer 912. The initial offset may also be selected such that the processing for the pilot-2 OFDM symbol can be completed before the arrival of the next OFDM symbol, so that the symbol timing obtained from the pilot-2 OFDM symbol may be applied to this next OFDM symbol.

Referring back to FIG. 9, a DFT unit 914 performs an L₂-point DFT on the L₂ input samples collected by sample buffer 912 and provides L₂ frequency-domain values for L₂ received pilot symbols. If the start of the sample window is not aligned with the start of the pilot-2 OFDM symbol (i.e., T_{W}≠T_{S}), then the channel impulse response is circularly shifted, which means that a front portion of the channel impulse response wraps around to the back. A pilot demodulation unit 916 removes the modulation on the L₂ received pilot symbols by multiplying the received pilot symbol Rₖ for each pilot subband k with the complex-conjugate of the known pilot symbol Pₖ* for that subband, or Rₖ·Pₖ*. Unit 916 also sets the received pilot symbols for the unused subbands to zero symbols. An IDFT unit 918 then performs an L₂-point IDFT on the L₂ pilot demodulated symbols and provides L₂ time-domain values, which are L₂ taps of an impulse response of the communication channel between base station 110 and wireless device 150.

FIG. 10B shows the L₂-tap channel impulse response from IDFT unit 918. Each of the L₂ taps is associated with a complex channel gain at that tap delay. The channel impulse response may be cyclically shifted, which means that the tail portion of the channel impulse response may wrap around and appear in the early portion of the output from IDFT unit 918.

Referring back to FIG. 9, a symbol timing searcher 920 may determine the symbol timing by searching for the peak in the energy of the channel impulse response. The peak detection may be achieved by sliding a “detection” window across the channel impulse response, as indicated in FIG. 10B. The detection window size may be determined as described below. At each window starting position, the energy of all taps falling within the detection window is computed.

FIG. 10C shows a plot of the energy of the channel taps at different window starting positions. The detection window is shifted to the right circularly so that when the right edge of the detection window reaches the last tap at index L₂, the window wraps around to the first tap at index 1. Energy is thus collected for the same number of channel taps for each window starting position.

The detection window size L_{W} may be selected based on the expected delay spread of the system. The delay spread at a wireless device is the time difference between the earliest and latest arriving signal components at the wireless device. The delay spread of the system is the largest delay spread among all wireless devices in the system. If the detection window size is equal to or larger than the delay spread of the system, then the detection window, when properly aligned, would capture all of the energy of the channel impulse response. The detection window size L_{W} may also be selected to be no more than half of L₂ (or L_{W}<L₂/2) to avoid ambiguity in the detection of the beginning of the channel impulse response. The beginning of the channel impulse response may be detected by (1) determining the peak energy among all of the L₂ window starting positions and (2) identifying the rightmost window starting position with the peak energy, if multiple window starting positions have the same peak energy. The energies for different window starting positions may also be averaged or filtered to obtain a more accurate estimate of the beginning of the channel impulse response in a noisy channel. In any case, the beginning of the channel impulse response is denoted as T_{B}, and the offset between the start of the sample window and the beginning of the channel impulse response is T_{OS}=T_{B}−T_{W}. Fine symbol timing may be uniquely computed once the beginning of the channel impulse response T_{B} is determined.

Referring to FIG. 10A, the fine symbol timing is indicative of the start of the received OFDM symbol. The fine symbol timing Ts may be used to accurately and properly place a “DFT” window for each subsequently received OFDM symbol. The DFT window indicates the specific N input samples (from among N+C input samples) to collect for each received OFDM symbol. The N input samples within the DFT window are then transformed with an N-point DFT to obtain N received data/pilot symbols for the received OFDM symbol. Accurate placement of the DFT window for each received OFDM symbol is needed in order to avoid (1) inter-symbol interference (ISI) from a preceding or next OFDM symbol, (2) degradation in channel estimation (e.g., improper DFT window placement may result in an erroneous channel estimate), (3) errors in processes that rely on the cyclic prefix (e.g., frequency tracking loop, automatic gain control (AGC), and so on), and (4) other deleterious effects.

The pilot-2 OFDM symbol may also be used to obtain a more accurate frequency error estimate. For example, the frequency error may be estimated using the pilot-2 sequences and based on equation (3). In this case, the summation is performed over L₂ samples (instead of L₁ samples) for the pilot-2 sequence.

The channel impulse response from IDFT unit 918 may also be used to derive a frequency response estimate for the communication channel between base station 110 and wireless device 150. A unit 922 receives the L₂-tap channel impulse response, circularly shifts the channel impulse response so that the beginning of the channel impulse response is at index 1, inserts an appropriate number of zeros after the circularly-shifted channel impulse response, and provides an N-tap channel impulse response. A DFT unit 924 then performs an N-point DFT on the N-tap channel impulse response and provides the frequency response estimate, which is composed of N complex channel gains for the N total subbands. OFDM demodulator 160 may use the frequency response estimate for detection of received data symbols in subsequent OFDM symbols. The channel estimate may also be derived in some other manner.

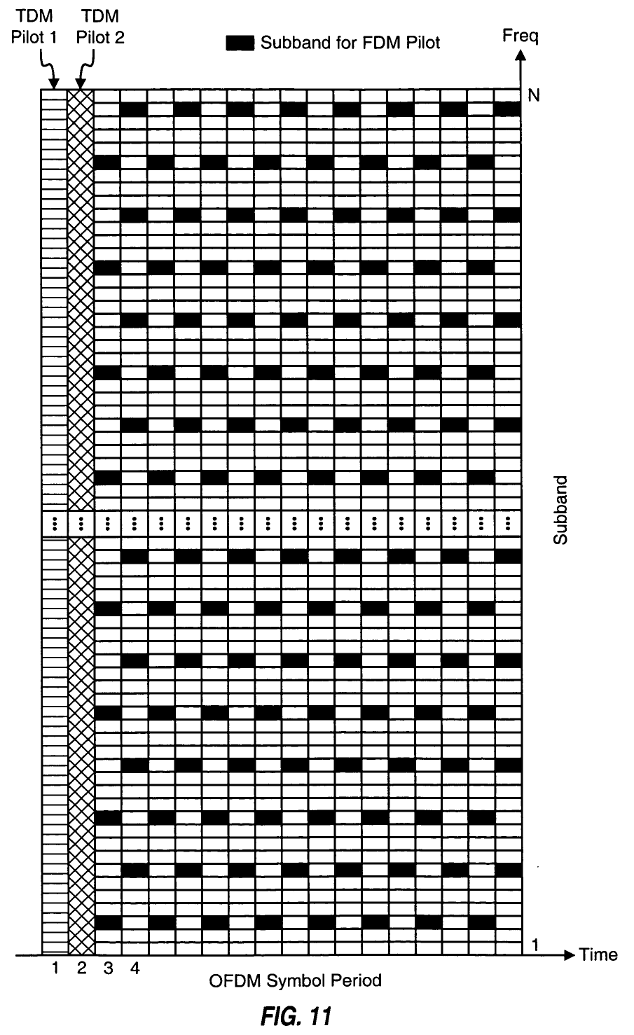

FIG. 11 shows a pilot transmission scheme with a combination of TDM and FDM pilots. Base station 110 may transmit TDM pilots 1 and 2 in each super-frame to facilitate initial acquisition by the wireless devices. The overhead for the TDM pilots is two OFDM symbols, which may be small compared to the size of the super-frame. The base station may also transmit an FDM pilot in all, most, or some of the remaining OFDM symbols in each super-frame. For the embodiment shown in FIG. 11, the FDM pilot is sent on alternating sets of subbands such that pilot symbols are sent on one set of subbands in even-numbered symbol periods and on another set of subbands in odd-numbered symbol periods. Each set contains a sufficient number of (L_{fdm}) subbands to support channel estimation and possibly frequency and time tracking by the wireless devices. The subbands in each set may be uniformly distributed across the N total subbands and evenly spaced apart by S_{fdm}=N/L_{fdm} subbands. Furthermore, the subbands in one set may be staggered or offset with respect to the subbands in the other set, so that the subbands in the two sets are interlaced with one another. As an example, N=4096, L_{fdm}=512, S_{fdm}=8, and the subbands in the two sets may be staggered by four subbands. In general, any number of subband sets may be used for the FDM pilot, and each set may contain any number of subbands and any one of the N total subbands.

A wireless device may use TDM pilots 1 and 2 for initial synchronization, e.g., frame synchronization, frequency offset estimation, and fine symbol timing acquisition (for proper placement of the DFT window for subsequent OFDM symbols). The wireless device may perform initial synchronization, for example, when accessing a base station for the first time, when receiving or requesting data for the first time or after a long period of inactivity, when first powered on, and so on.

The wireless device may perform delayed correlation of the pilot-1 sequences to detect for the presence of a pilot-1 OFDM symbol and thus the start of a super-frame, as described above. Thereafter, the wireless device may use the pilot-1 sequences to estimate the frequency error in the pilot-1 OFDM symbol and to correct for this frequency error prior to receiving the pilot-2 OFDM symbol. The pilot-1 OFDM symbol allows for estimation of a larger frequency error and for more reliable placement of the DFT window for the next (pilot-2) OFDM symbol than conventional methods that use the cyclic prefix structure of the data OFDM symbols. The pilot-1 OFDM symbol can thus provide improved performance for a terrestrial radio channel with a large multi-path delay spread.

The wireless device may use the pilot-2 OFDM symbol to obtain fine symbol timing to more accurately place the DFT window for subsequent received OFDM symbols. The wireless device may also use the pilot-2 OFDM symbol for channel estimation and frequency error estimation. The pilot-2 OFDM symbol allows for fast and accurate determination of the fine symbol timing and proper placement of the DFT window.

The wireless device may use the FDM pilot for channel estimation and time tracking and possibly for frequency tracking. The wireless device may obtain an initial channel estimate based on the pilot-2 OFDM symbol, as described above. The wireless device may use the FDM pilot to obtain a more accurate channel estimate, particularly if the FDM pilot is transmitted across the super-frame, as shown in FIG. 11. The wireless device may also use the FDM pilot to update the frequency tracking loop that can correct for frequency error in the received OFDM symbols. The wireless device may further use the FDM pilot to update a time tracking loop that can account for timing drift in the input samples (e.g., due to changes in the channel impulse response of the communication channel).

The synchronization techniques described herein may be implemented by various means. For example, these techniques may be implemented in hardware, software, or a combination thereof. For a hardware implementation, the processing units at a base station used to support synchronization (e.g., TX data and pilot processor 120) may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a combination thereof. The processing units at a wireless device used to perform synchronization (e.g., synchronization and channel estimation unit 180) may also be implemented within one or more ASICs, DSPs, and so on.

For a software implementation, the synchronization techniques may be implemented with modules (e.g., procedures, functions, and so on) that perform the functions described herein. The software codes may be stored in a memory unit (e.g., memory unit 192 in FIG. 1) and executed by a processor (e.g., controller 190). The memory unit may be implemented within the processor or external to the processor.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

1. A method of transmitting pilots in a wireless broadcast system utilizing orthogonal frequency division multiplexing (OFDM), comprising:
transmitting a first pilot on a first set of frequency subbands in a time division multiplexed (TDM) manner with data, wherein the first set includes a fraction of N total frequency subbands in the system, where N is an integer greater than one; and
transmitting a second pilot on a second set of frequency subbands in a TDM manner with the data, wherein the second set includes more subbands than the first set, and wherein the first and second pilots are used for synchronization by receivers in the system.

2. The method of claim 1, wherein the first and second pilots are transmitted periodically in each frame of a predetermined time duration.

3. The method of claim 2, wherein the first pilot is transmitted at the start of each frame and the second pilot is transmitted next in the frame.

4. The method of claim 2, wherein the first pilot is used to detect for start of each frame, and wherein the second pilot is used to determine symbol timing indicative of start of received OFDM symbols.

5. The method of claim 1, wherein the first pilot is transmitted in one OFDM symbol.

6. The method of claim 1, wherein the first set includes N/2^{M} frequency subbands, where M is an integer greater than one.

7. The method of claim 1, wherein the second pilot is transmitted in one OFDM symbol.

8. The method of claim 1, wherein the second set includes N/2^{K} frequency subbands, where K is an integer one or greater.

9. The method of claim 1, wherein the second set includes N/2 frequency subbands.

10. The method of claim 1, wherein the frequency subbands in each of the first and second sets are uniformly distributed across the N total frequency subbands.

11. The method of claim 1, wherein the first pilot is further used for frequency error estimation by the receivers.

12. The method of claim 1, wherein the second pilot is further used for channel estimation by the receivers.

13. The method of claim 1, further comprising:
transmitting a third pilot on a third set of frequency subbands in a frequency division multiplexed (FDM) manner with the data, wherein the first and second pilots are used by the receivers to obtain frame and symbol timing, and wherein the third pilot is used by the receivers for frequency and time tracking.

14. The method of claim 13, wherein the third pilot is further used for channel estimation.

15. The method of claim 1, further comprising:
generating the first and second pilots with a pseudo-random number (PN) generator.

16. The method of claim 15, further comprising:
initializing the PN generator to a first initial state for the first pilot, and
initializing the PN generator to a second initial state for the second pilot.

17. The method of claim 15, wherein the PN generator is also used to scramble data prior to transmission.

18. The method of claim 1, further comprising:
generating the first pilot, the second pilot, or each of the first and second pilots with data selected to reduce peak-to-average variation in a time-domain waveform for the pilot.

19. An apparatus in an orthogonal frequency division multiplexing (OFDM) system, comprising:
a modulator operative to provide a first pilot on a first set of frequency subbands in a time division multiplexed (TDM) manner with data and to provide a second pilot on a second set of frequency subbands in a TDM manner with the data, wherein the first set includes a fraction of N total frequency subbands in the system, where N is an integer greater than one, and wherein the second set includes more subbands than the first set; and
a transmitter unit operative to transmit the first and second pilots, wherein the first and second pilots are used for synchronization by receivers in the system.

20. The apparatus of claim 19, wherein the first and second pilots are transmitted periodically in each frame of a predetermined time duration.

21. An apparatus in an orthogonal frequency division multiplexing (OFDM) system, comprising:
means for transmitting a first pilot on a first set of frequency subbands in a time division multiplexed (TDM) manner with data, wherein the first set includes a fraction of N total frequency subbands in the system, where N is an integer greater than one; and
means for transmitting a second pilot on a second set of frequency subbands in a TDM manner with the data, wherein the second set includes more subbands than the first set, and wherein the first and second pilots are used for synchronization by receivers in the system.

22. The apparatus of claim 21, wherein the first and second pilots are transmitted periodically in each frame of a predetermined time duration.

23. A method of performing synchronization in an orthogonal frequency division multiplexing (OFDM) system, comprising:
processing a first pilot received via a communication channel to detect for start of each frame of a predetermined time duration, wherein the first pilot is transmitted on a first set of frequency subbands in a time division multiplexed (TDM) manner with data, and wherein the first set includes a fraction of N total frequency subbands in the system, where N is an integer greater than one; and
processing a second pilot received via the communication channel to obtain symbol timing indicative of start of received OFDM symbols, wherein the second pilot is transmitted on a second set of frequency subbands in a TDM manner with the data, and wherein the second set includes more subbands than the first set.

24. The method of claim 23, wherein the first and second pilots are transmitted periodically in each frame of a predetermined time duration.

25. The method of claim 23, wherein the processing the first pilot comprises
deriving a detection metric based on delayed correlation between samples in a plurality of sample sequences received for the first pilot, and
detecting for the start of each frame based on the detection metric.

26. The method of claim 25, wherein the start of each frame is further detected based on a metric threshold.

27. The method of claim 26, wherein the start of a frame is detected if the detection metric exceeds the metric threshold for a predetermined amount of time during the first pilot.

28. The method of claim 26, wherein the start of a frame is detected if the detection metric exceeds the metric threshold for a percentage of time during the first pilot and remains below the metric threshold for a predetermined amount of time thereafter.

29. The method of claim 23, wherein the processing the first pilot comprises
deriving a detection metric based on direct correlation between samples received for the first pilot and expected values for the first pilot, and
detecting for the start of each frame based on the detection metric.

30. The method of claim 23, wherein the processing of the second pilot comprises
obtaining a channel impulse response estimate based on the received second pilot,
determining start of the channel impulse response estimate, and
deriving the symbol timing based on the start of the channel impulse response estimate.

31. The method of claim 30, wherein the channel impulse response estimate comprises L channel taps, where L is an integer greater than one, and wherein the start of the channel impulse response estimate is determined based on the L channel taps.

32. The method of claim 31, wherein the determining the start of the channel impulse response estimate comprises
determining, for each of a plurality of window positions, energy of channel taps falling within a window, and
setting the start of the channel impulse response estimate to a window position with highest energy among the plurality of window positions.

33. The method of claim 32, wherein the start of the channel impulse response estimate is set to a rightmost window position with the highest energy if multiple window positions have the highest energy.

34. The method of claim 23, further comprising:
processing the first pilot to estimate frequency error in a received OFDM symbol for the first pilot.

35. The method of claim 23, further comprising:
processing the second pilot to estimate frequency error in a received OFDM symbol for the second pilot.

36. The method of claim 23, further comprising:
processing the second pilot to obtain a channel estimate for the communication channel.

37. The method of claim 23, further comprising:
processing a third pilot received via the communication channel for frequency and time tracking, wherein the third pilot is transmitted on a third set of frequency subbands in a frequency division multiplexed (FDM) manner with the data.

38. An apparatus in an orthogonal frequency division multiplexing (OFDM) system, comprising:
a frame detector operative to process a first pilot received via a communication channel to detect for start of each frame of a predetermined time duration, wherein the first pilot is transmitted on a first set of frequency subbands in a time division multiplexed (TDM) manner with data, and wherein the first set includes a fraction of N total frequency subbands in the system, where N is an integer greater than one; and
a symbol timing detector operative to process a second pilot received via the communication channel to obtain symbol timing indicative of start of received OFDM symbols, wherein the second pilot is transmitted on a second set of frequency subbands in a TDM manner with the data, and wherein the second set includes more subbands than the first set.

39. The apparatus of claim 38, wherein the first and second pilots are transmitted periodically in each frame of a predetermined time duration.

40. The apparatus of claim 38, wherein the frame detector is operative to derive a detection metric based on correlation between samples in a plurality of sample sequences received for the first pilot, and to detect for the start of each frame based on the detection metric.

41. The apparatus of claim 38, wherein the symbol timing detector is operative to obtain a channel impulse response estimate based on the received second pilot, determine start of the channel impulse response estimate, and derive the symbol timing based on the start of the channel impulse response estimate.

42. An apparatus in an orthogonal frequency division multiplexing (OFDM) system, comprising:
means for processing a first pilot received via a communication channel to detect for start of each frame of a predetermined time duration, wherein the first pilot is transmitted on a first set of frequency subbands in a time division multiplexed (TDM) manner with data, and wherein the first set includes a fraction of N total frequency subbands in the system, where N is an integer greater than one; and
means for processing a second pilot received via the communication channel to obtain symbol timing indicative of start of received OFDM symbols, wherein the second pilot is transmitted on a second set of frequency subbands in a TDM manner with the data, and wherein the second set includes more subbands than the first set.

43. The apparatus of claim 42, wherein the first and second pilots are transmitted periodically in each frame of a predetermined time duration.
